(19) United States
(12) Patent Application Publication
(10) Pub. No.: US 2026/0061526 A1
(43) Pub. Date: Mar. 5, 2026

(54) Alloy and Method for Selecting a Suitable Alloy for Repairing a Bearing Raceway

(71) Applicant: Carl Ribaudo, North Canton, OH (US)

(72) Inventor: Carl Ribaudo, North Canton, OH (US)

(21) Appl. No.: 19/308,539

(22) Filed: Aug. 25, 2025

Related U.S. Application Data
(60) Provisional application No. 63/689,749, filed on Sep. 1, 2024.
(60) Provisional application No. 63/711,121, filed on Oct. 23, 2024.

(51) Int. Cl. B23K 31/12; B23P 6/04

(52) U.S. Cl. CPC B23K 31/12; B23P 6/04; F16C 2237/00

(57) ABSTRACT

The present invention permits the repair of rolling contact bearings through a unique combination of material selection and repair process. Bearing raceways may become damaged during their service life. Once damage has occurred, the bearing may need to be replaced. Repairing damaged raceways has not been a viable option due to the combination of high carbon content found in the traditional material alloys along with the application of heat needed to fuse the repair material to the existing raceway. This combination can lead to exceedingly high stresses and brittle microstructure in the attempted repair location. The present invention overcomes the repair issues through the unique selection of an alloy steel capable of providing sufficient hardness while decreasing the resulting thermoelastic stress that occurs during the transformation from austenite to martensite at the repair location thereby reducing the chance of cracking following the repair.

### CROSS-REFERENCE TO RELATED APPLICATION

The present application claims priority to, and the benefit of, U.S. Provisional Patent Application No. 63/689,749, which was filed on Sep. 1, 2024, and U.S. Provisional Patent Application No. 63/711,121, which was filed on Oct. 23, 2024, both of which are incorporated herein by reference in their entirety.

### FIELD OF THE INVENTION

The present invention relates generally to the field of rolling contact bearings. More specifically, the present invention relates to the selection of bearing material alloys and a method for repairing rolling contact bearing components. Rolling contact bearings, commonly known as ball, roller, needle, or tapered bearings generally consist of three main components: an outer raceway, inner raceway, and a plurality of balls or rollers that may further include a roller/ball cage for retaining and aligning said rollers/balls. The balls or rollers are positioned between the inner and outer raceways and allow for smooth, low friction, rolling motion of the inner raceway relative to the outer raceway. Rolling contact bearings are commonly used in countless applications and come in a very wide variety of sizes and load rating capacities. They are designed to carry radial and axial loads that are commonly associated with rotating machinery, gear shafts, motor drives, and wheel hubs, just to name a few. While the rolling contact bearings are typically designed to last a million or more revolutions in their application, they can eventually begin to wear out.

Over a period of time and potentially millions of revolutions, the radial and axial loads applied to the bearing components can begin to create small cracks, pitting, and/or spalls on the contact surfaces of the outer or inner raceways. Once this occurs, additional usage of the rolling contact bearing can lead to further cracking and may at some point lead to breakage of one or both raceways. Additionally, damage to the raceway surface may eventually cause damage to the ball/roller elements as well. At this point, the bearing is usually replaced since repairing of the bearing components is usually not possible. Current repair methods that use a filler material can restore a damaged bearing raceway back to its original size and surface finish but cannot achieve the same strength and surface hardness of the original raceway until now. The present invention discloses a method for selecting a suitable alloy for the filler material thus restoring the bearing raceway completely back to original condition. Accordingly, the present disclosure makes specific reference thereto. Nonetheless, it is to be appreciated that aspects of the present invention are also equally applicable to other like applications, devices and methods of manufacture.

### BACKGROUND

By way of background, rolling contact bearings include a plurality of rolling elements (rollers or balls) that rotate while moving between the surfaces of two coaxial cylindrical bodies called raceways. Rolling contact bearings have been used in rotating machinery, gear shafts, motor drives, and wheel hubs for hundreds of years. One of the earliest ball bearing inventions was patented by Philip Vaughn of Carmarthen, Wales in 1794. Vaughn described how iron balls running in a groove between the wheel and axle would reduce friction. This was a significant finding since high levels of friction are common in non-rolling contact bearings, commonly known as sleeve, plain, or journal bearings. Sleeve or journal bearings rely on the sliding of one cylindrical surface onto another cylindrical surface, which create higher levels of friction than what is found in rolling contact bearings. Rolling contact bearings on the other hand, typically do not slide, but rather roll on balls or rollers which separate the inner and outer bearing raceways.

Rolling contact bearings achieve very low friction due to the balls/rollers, but there is a trade-off. Since the balls or rollers either make point or line contact with the inner and outer raceways as they rotate, very high contact stress known as hertzian stress is imparted into the bearing raceways. In addition to high contact stress, typical rolling contact bearings may be used in applications where they are expected to last 50,000 hours or longer. Using this as an example, a rolling contact bearing rotating at 1800 revolutions per minute (rpm) over the 50,000 hours would complete 5.4 billion revolutions. The high contact stress coupled with millions of revolutions can eventually cause a bearing to wear out.

The surfaces of bearing raceways or element bodies can become damaged during normal operation due to the high contact stresses. Rolling contact (or hertzian) fatigue occurs as a result of radial and axial loads being repeatedly applied as the bearing rotates. One or more small cracks can be initiated at or below the raceway or body surface. With each revolution of the bearing raceway, cracks continue to grow below the surface at the damage location. Eventually the small cracks connect and cause material to become detached from the raceway or body which leaves a rough crater (i.e. a “spall”) on the surface of the bearing raceway. At the edges of the spall, the stress increases which promotes further cracking and removal of material from the surface. Fatigue damage results in decreased bearing life as well as excessive noise and vibration generation. Ultimately the damage can lead to premature replacement of the bearing along with lost production time and potential damage to other components.

If the damage to the bearing raceway surface is relatively small and localized, it may be possible to repair the bearing raceway. One method for repairing relatively small locations on a bearing raceway is spot grinding. Spot grinding is well known in the art, and it uses a grinding wheel to remove a small amount of material in and around the damage location leaving the repaired surface smooth and free from any cracks or pits. However, there are limits to the size of a spall that can be removed by spot grinding without the stress on the remaining surface of the raceway or body becoming excessive.

If the damage to the bearing raceway cannot be repaired by spot grinding alone, an alternative repair method might be to use a process known as directed-energy deposition (DED). DED uses a high energy source such as a laser to melt a filler material to fill-in the pits and spalls found in the damaged surface location. The filler material, generally supplied in the form of powder metal or metal wire, is melted and becomes metallurgically bonded to the bearing raceway. The filler material once solidified creates a layer of material called a cladding. Prior to DED, stock on the damaged raceway or body is removed using hard turning or grinding to produce a uniform diameter that is free of defects. Coverage of the surface of the substrate with cladding is then achieved by moving the substrate relative to the energy source and filler material in overlapping deposition passes. The passes may be in a single layer or in multiple layers. Thermal treatments such as tempering may be performed on the cladded component. The surface of the cladding is then ground to re-establish the original diameter. Additional operations such as superfinishing or honing may be performed to produce the desired surface texture on the raceway or body.

The use of DED to repair bearing raceways has been attempted in the past with limited success. For instance, patent application US 2024/0255027, titled: “A Method for Manufacturing a Rolling or Plain Bearing”, describes a repair process for bearing raceways using DED. In this publication, the author suggests adding boron (B) to the DED filler material alloy. Specifically, the author states that “the steel wire and/or steel metal powder preferably comprises Carbon (C) and Boron (B) as hardening mechanisms.” The author further points out that “a steel wire and/or steel metal powder which only comprises C as hardening mechanism may not provide a surface a surface with sufficient surface hardness without a high risk of cracking.” Thus, the author's stated goal of the boron addition to the filler material composition is to cause the martensitic structure to be inherently harder. The amount of boron specified in this application is 0.50 to 1.20% by weight. As one skilled in the art would recognize, the suggested percentage of boron referenced in the application is more than 100 times the level that is commonly found in conventional boron-treated steels such as AISI 50B46 steel. In the specific case for AISI 50B46 steel, boron is added to improve hardenability as opposed to increase the hardness of the martensitic structure itself. The author of the publication also suggests that an ideal carbon (C) range of 0.10 to 0.50% is desired for the DED filler material composition. However, a filler material made from this alloy composition is only expected to produce a minimum surface hardness of only 55 HRC (hardness using the Rockwell “C” scale), which does not meet the generally accepted minimum surface and near surface hardness of 58 HRC to resist hertzian fatigue. Therefore, this alloy composition will provide only very limited success.

Other DED filler material compositions such as cemented tungsten carbide have been found to have adequate overall hardness, but they contain hard and sharp particles within the microstructure that create localized stress concentrations leaving the alloy inadequate in strength for bearing applications. For example, Chen, Shihui, et al. “Study on the Microstructure and Performance of the Multi-Field Composite-Assisted Laser Cladding of Nickel-Based Tungsten Carbide Coatings.” Metals (2075-4701) 14.10 (2024) published their work in this area. These limitations have led to the recognition that a different alloy is needed for the successful use of DED in the manufacture or repair of bearing components and will be disclosed herein.

Therefore, there exists a long felt need in the art for a repair method that can restore damaged bearing raceways back to their original surface condition while also maintaining sufficient surface hardness. Since spot grinding can only repair small, localized damage locations, there is a long felt need in the art for a repair method that can be used on larger damage locations. Current repair techniques using the DED process can repair larger damage locations, however they fail to adequately restore damaged bearing raceways since current filler material alloy compositions are incapable of achieving the minimum surface hardness goals. Ideally, the DED process is preferrable since it can restore a damaged surface back to its original shape and surface finish, but it cannot restore the surface back to its original hardness. There exists a long felt need in the art for a DED filler material alloy that can provide a minimum surface hardness of 58 HRC or better without causing other detrimental effects on the microstructure of the repair location.

The subject matter disclosed and claimed herein comprises a method for selecting a steel alloy that when used as a filler material in the DED process, will restore a damaged bearing raceway back to its original shape, size, surface finish, and surface hardness. One embodiment thereof has the preferable compositional limits for the novel DED filler material as listed below in Table 1:

TABLE 1
First Embodiment Compositional Limits for the Present
Invention DED Filler Material
Elemental content in percentage by weight

| | Fe | C | Mn | Si | Cr | Ni | Mo |
|---|---|---|---|---|---|---|---|
| Min % | 97.50 | 0.60 | 0.05 | 0.05 | 0.05 | 1.70 | 0.05 |
| Max % | 88.00 | 0.80 | 1.00 | 0.40 | 1.80 | 7.00 | 1.00 |

The preferrable compositional limits for the novel DED filler material shown in Table 1 further specifies that the retained austenite preferable range is between 10 and 30 percent to minimize cracking upon cooling of the repair location.

Another embodiment has the preferable compositional limits for the novel DED filler material as listed below in Table 2:

TABLE 2
Second Embodiment Compositional Limits for the Present
Invention DED Filler Material
Elemental content in percentage by weight

| | Fe | C | Mn | Si | Cr | Ni | Mo | V |
|---|---|---|---|---|---|---|---|---|
| Min % | 98.23 | 0.55 | 0.05 | 0.05 | 0.05 | 1.00 | 0.05 | 0.02 |
| Max % | 88.20 | 0.80 | 1.50 | 1.20 | 2.00 | 5.00 | 1.00 | 0.30 |

The second preferrable compositional limits for the novel DED filler material shown in Table 2 further specifies that the maximum martensite start temperature (Mₛ) be limited to 200° C. to minimize cracking upon cooling of the repair location. Both preferrable embodiments herein have overlapping composition percentages for C, Mn, Si, Cr, Ni, and Mo. The first embodiment may additionally include V as well but does not specify a preferable minimum or maximum range. Either embodiment described herein for selecting a suitable DED filler material alloy could be used in conjunction with the DED process for other applications besides bearing raceway repairs as well.

In this manner, the novel material alloy selection method of the present invention accomplishes all of the forgoing objectives, and provides a relatively easy, convenient and effective solution of using the DED process for repairing bearing raceways or other components needing a surface hardness of 58 HRC or higher.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, has the preferable compositional limits for the novel DED filler material as previously listed in Table 1 herein. This embodiment further specifies that the retained austenite preferable range is between 10 and 30 percent to minimize cracking upon cooling of the repair location. A second embodiment has the preferable compositional limits for the novel DED filler material as previously listed in Table 2 herein. The second embodiment further specifies that the maximum martensite start temperature (Mₛ) be limited to 200° C. to minimize cracking upon cooling of the repair location. Both embodiments herein have overlapping composition percentages for C, Mn, Si, Cr, Ni, and Mo. The first embodiment may additionally include V as well but does not specify a preferable minimum or maximum range. Either embodiment described herein for selecting a suitable DED filler material alloy could be used in conjunction with the DED process for other applications besides bearing raceway repairs as well.

The novel DED filler material selection method can be used on small, medium, or even large repair locations on bearing raceways. After finishing the DED process the repaired raceway surface will be restored to its original shape, size, and surface finish. In addition, since the DED filler material selected using the present invention selection process, the repaired raceway surface hardness will also meet or exceed the 58 HRC goal as well. Thus, the novel filler material selection method and the DED repair process will allow a previously damaged bearing raceway to be fully repaired and fully restored back to its original shape, size, surface finish, and surface hardness.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an exploded perspective view of a conventional rolling contact bearing having a location of surface damage;

FIG. 2A illustrates a partial sectional view of the surface damage location on the bearing raceway shown in FIG. 1;

FIG. 2B illustrates a sequence of operations in the DED repair process of a raceway having an original diameter D;

FIG. 3A illustrates a simplified DED processing cross sectional schematic with powder filler material;

FIG. 3B illustrates a buildup of cladding passes to create a cladding layer using the DED process;

FIG. 4 illustrates the process flow selecting a suitable alloy for repairing a bearing raceway.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a repair method that can restore damaged bearing raceways back to their original surface condition while also maintaining sufficient surface hardness. Since spot grinding can only repair small, localized damage locations, there is a long felt need in the art for a repair method that can be used on larger damage locations. Current repair techniques using the DED process can repair larger damage locations, however they fail to adequately restore damaged bearing raceways since current filler material alloy compositions are incapable of achieving the minimum surface hardness goals. Ideally, the DED process is preferrable since it can restore a damaged surface back to its original shape and surface finish, but it cannot restore the surface back to its original hardness. There exists a long felt need in the art for a DED filler material alloy that can provide a minimum surface hardness of 58 HRC or better without causing other detrimental effects on the microstructure of the repair location.

The present invention method of selecting a suitable alloy for a DED filler material alloy starts with achieving the hardness requirement of 59 HRC minimum for a single pass composite requirement, assuming that tempering due to multi-pass DED layers will temper the hardness down to 58 HRC. This requirement is met with a steel having a primarily martensitic structure and sufficient carbon content. The hardness of the martensite formed prior to tempering increases with increased carbon content as shown in FIG. 7 of Practical Data for Metallurgists, 18th edition, TimkenSteel (2017). FIG. 7 is a graph showing the hardness of quenched steel as a function of carbon content and the amount of martensite. The graph shows that as the carbon content percentage increases, so does the hardness of the alloy. The graph also shows that the hardness of the steel also increases with an increased proportion of freshly formed martensite in the microstructure. This is because other potential phases such as ferrite, pearlite, bainite, and retained austenite are considerably softer. With non-DED processing, detrimental carbide networks may form if the carbon content is excessive whereas the rapid cooling from DED processing prevents the formation of those networks.

In addition to selecting an alloy that can achieve the hardness requirement of 58 HRC minimum, the present invention selection process considers the prevention of cracking due to high internal stresses during and following DED processing. The likelihood of cracking during DED increases with increased carbon content. Tensile stresses form in the cladding during initial cooling from the DED process due to the thermoelastic contraction of the cladding while being restricted by the adjacent substrate which is cooler and more rigid. Transformation from austenite to martensite creates a volumetric expansion which offsets the thermoelastic contraction to create a net compressive stress state. Thermoelastic contraction continues to occur during subsequent cooling. It has been learned that, if the transformation start temperature, Mₛ, of the cladding material is low enough, a compressive residual stress state in the cladding can remain after cooling to room temperature. Thus, an innovative combination of offsetting the thermoelastic contraction due to the initial cooling of the DED process along with the volumetric expansion due to the transformation from austenite to martensite has brought about a novel DED filler material that was not previously possible. In addition, transformation at a lower Mₛ allows the martensitic transformation to occur when the temperature is more uniform within the cladding.

It has also been learned that stress in the cladding may also be further reduced by preheating or simultaneously heating the workpiece with an external source such as an induction heater to provide a more uniform temperature during transformation. The beneficial effect of this approach is maximized within the Mₛ is slightly above the preheating or simultaneous heating temperature. The temperature used for this heating may be limited by the need to avoid excessive dimensional change in the bearing component. A maximum allowable uniform holding temperature in the range of 135 to 150° C. would be typical for bearing components.

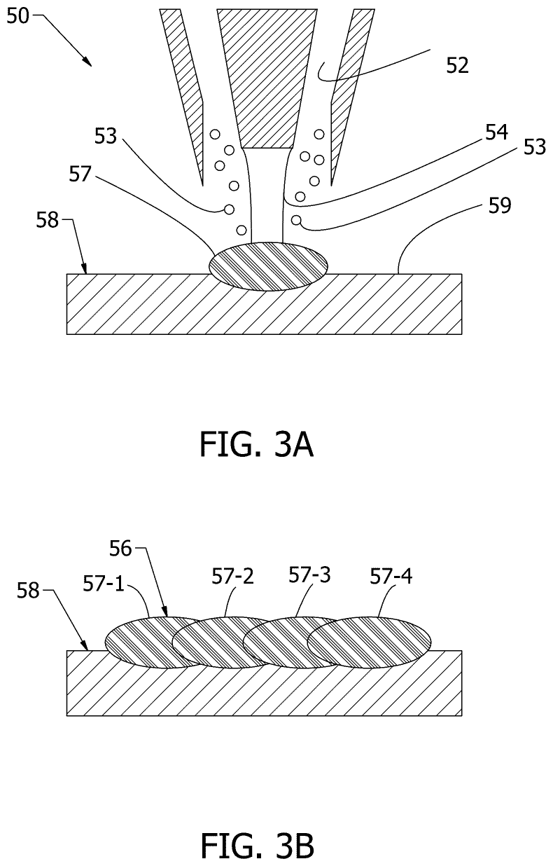

The input of heat during the formation of multiple overlapping passes such as those shown in FIG. 3B causes the non-remelted portion of the cladding to experience tempering of the martensite which lowers the hardness of that phase. Some of the retained austenite formed earlier may transform during this heating which would provide a partially offsetting increase in the overall hardness. The alloy of the cladding needs to have sufficient resistance to the effects of heating from multiple passes to maintain adequate hardness at the end of cladding.

The current invention applies an alloy steel using DED that provides sufficient hardness and toughness within the cladding while decreasing the tensile stress during processing to help prevent cracking. The carbon content of the feedstock is selected to be sufficiently high to provide a cladding hardness of at least 59 HRC minimum for a single pass composite requirement, assuming that tempering due to multi-pass DED layers will temper the hardness down to 58 HRC after processing.

The composition of the alloy is also selected to both decrease the stress from thermal gradient during the phase transformation from austenite to martensite and to allow the retention of a sufficient amount of austenite to toughen the material. The reduction in the thermal gradient is created by selecting the alloy composition to produce a martensite start temperature, Mₛ, that is close to the substrate temperature. A sufficiently low Mₛ temperature also yields sufficient retained austenite. The Mₛ temperature is determined by the amount of carbon and other elements in the alloy and has been estimated by: Practical Data for Metallurgists, 18th edition, TimkenSteel (2017) using the equation below:

$$Ms ( ° C . ) = ( ( 930 − 600 ⋆ C − 60 ⋆ Mn − 20 ⋆ Si − 50 ⋆ Cr − 30 ⋆ Ni − 20 ⋆ Mo ) − 32 ) / 1.8 \qquad [ Eq . 1 ]$$

Where the concentrations of elements are expressed in weight percentages:
C=Carbon
Mn=Manganese
Si=Silicon
Cr=Chromium
Ni=Nickel
Mo=Molybdenum

With the Mₛ temperature now estimated, the determination of the amount of retained austenite remaining after cooling to a given temperature, T (° C.), is the next step of the present invention method for selecting a suitable DED filler material alloy. An equation for the volume fraction of retained austenite can be determined using: Koistinen, Donald P. “A general equation prescribing extent of austenite-martensite transformation in pure Fe—C alloys and plain carbon steels.” Acta Metallurgica 7 (1959): 50-60. The equation for estimated retained austenite is shown below:

$${f}_{RA} = exp ( - 0.011 ⋆ ( {M}_{s} - T ) ) \qquad [ Eq . 2 ]$$

Where
f_{RA}=Retained austenite (volume fraction)
Mₛ=Martensite start temperature in ° C.
T=Room temperature in ° C.

In addition to a suitable equation for the volume fraction of retained austenite, this publication also includes FIG. 8, which is a graph showing hardness of martensite and austenite of iron alloys as a function of carbon content. Equations for microhardness of the freshly formed (untempered) martensite and of the austenite as a function of the carbon content of the alloy can be approximated by the following equations:

$${H}_{mart} ( HVN ) = - 1137.77 ⋆ {C}^{2} + 1708.78 ⋆ C + 205.09 \qquad [ Eq . 3 ]$$

$${H}_{RA} ( HVN ) = 51.741 ⋆ C + 104.18 \qquad [ Eq . 4 ]$$

Where
HVN=Vickers microhardness
Hₘₐᵣₜ=Microhardness (untempered) martensite in HVN
H_{RA}=Microhardness austenite in HVN
C=Weight percentage of Carbon

The microhardness of the composite microstructure of martensite and austenite in the cladding is then estimated using the law of mixtures. This is a well-known formula to those skilled in the art. The equation for the microhardness of the composite microstructure of martensite and austenite is given by the equation:

$$H ( HVN ) = ( 1 - {f}_{RA} ) ⋆ {H}_{mart} + {f}_{RA} ⋆ {H}_{RA} \qquad [ Eq . 5 ]$$

Where
HVN=Vickers microhardness
H=Microhardness composite microstructure in HVN
Hₘₐᵣₜ=Microhardness (untempered) martensite in HVN
H_{RA}=Microhardness austenite in HVN
f_{RA}=Retained austenite (volume fraction)

The final equation needed is a conversion from Vickers microhardness (HVN) to Rockwell C Scale Hardness (RHC). Using simple linear regression on the conversion table found within the Practical Data for Metallurgists publication previously cited, a linear equation was then created for the interval of 54.7 to 65.9 HRC. The linearized equation relating Vickers microhardness and Rockwell C Scale Hardness is given by the equation:

$$HRC = 0.0414 ⋆ HVN + 30.77 \qquad [ Eq . 6 ]$$

Where HVN=Vickers microhardness
   HRC=Rockwell C Scale Hardness

The microhardness of the martensite after multiple pass formation may be predicted by determining an equivalent isothermal tempering for a unit time. The effect of the alloying elements in the steel upon the microhardness for a uniform tempering cycle can be estimated using: Grange, R. A., C. R. Hribal, and L. F. Porter. “Hardness of tempered martensite in carbon and low-alloy steels.” Metallurgical Transactions A 8 (1977): 1775-1785.

The present invention, in one exemplary embodiment, is a novel DED filler material selection method that can be used on small, medium, or even large repair locations on bearing raceways. Further, the selected filler material using the present invention selection process may also be used in the manufacturing of new components in addition to repairing current components including but not limited to bearing raceways.

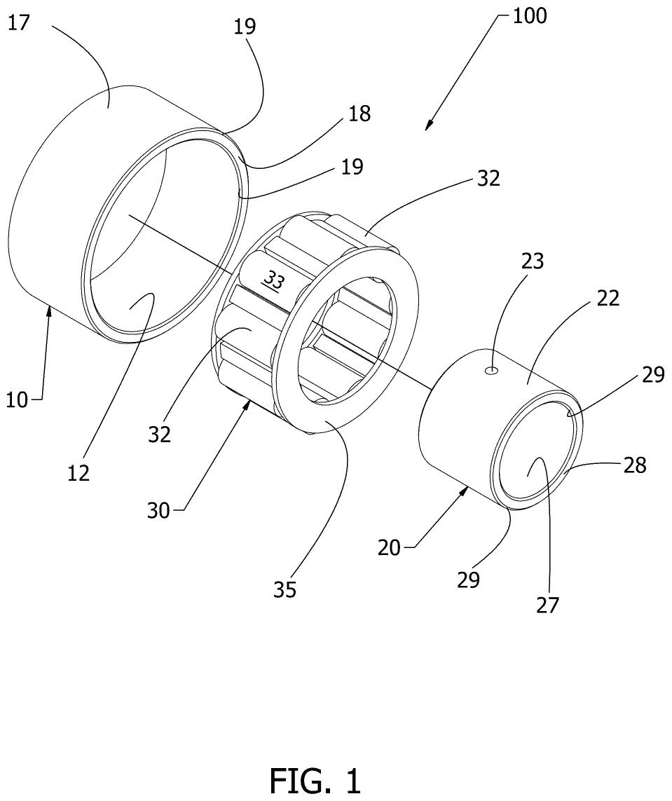

Referring initially to the drawings, FIG. 1 illustrates an exploded perspective view of a conventional rolling contact bearing having a location of surface damage. A conventional rolling contact bearing 100 is shown in an exploded state in FIG. 1 consisting primarily of three main components: the outer raceway 10, the inner raceway 20, and a plurality of rollers 32. Rollers 32 are shown throughout this application for simplicity. However, it should be noted that rolling contact bearings 100 could also include ball bearings instead of rollers. The innovative method described herein will interchangeably work for either type of bearing repair. Also, it should be appreciated that rollers 32 are positioned between the contact surface 12 of outer raceway 10 and the contact surface 22 of the inner raceway 20. Roller contact surfaces 33 are in direct contact with the contact surfaces 12 and 22 of outer raceway 10 and inner raceway 20, respectively. Roller assembly 30 may further include a roller cage 35 to retain and align the rollers 32 for smoother operation and better load distribution on the bearing.

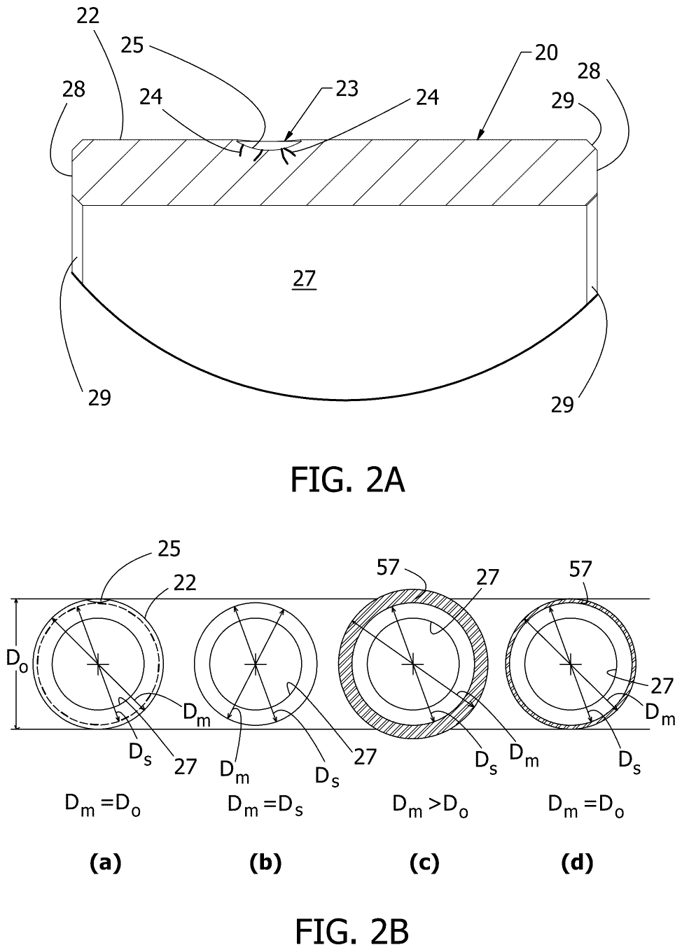

When assembled, rolling contact bearing 100 can be specified by three key dimensions, namely: outside diameter, inside diameter (or bore), and width. A typical application of a rolling contact bearing 100 would have it pressed into a support housing (not shown) and held in place by its outer diameter surface 17. Further, rolling contact bearing 100 is slid over a shaft or the like (not shown) and continues to make contact with the bearing along its inner diameter surface. To facilitate easier installation, outer raceway 10 may include a chamfer or fillet 19 along its raceway edge 18. Likewise, inner raceway 20 may include a chamfer or fillet 29 along its raceway edge 28. Damage location 23 is shown on contact surface 22 of inner raceway 20 and will be more fully explained in FIG. 2A herein.

FIG. 2A illustrates a partial sectional view of the surface damage location 23 on the inner raceway 20 as shown in FIG. 1. Contact surface 22 may become damaged at some point during the service life of rolling contact bearing 100. As previously described, hertzian stress is very high for rolling contact bearings due to the radial and axial loads placed upon the bearings. In addition to the high contact stress, a rolling contact bearing may be subjected to millions of revolutions over its service life. When this occurs, rolling contact bearing 100 may develop one or more damage locations 23 on either of its contact surfaces (22 or 12). Initially, microcracks 24 at the surface of the bearing may develop. Over time, the microcracks 24 may begin to grow and join together. When this occurs, the microcracks 24 may grow to the point where small pieces of bearing raceway material may break-off creating a spall 25. The bearing fragments get trapped between the contacting surfaces of the two raceways and the rollers (12, 22, and 33, respectively). If this happens, the entrapped bearing fragment may cause additional damage to the other raceways and rollers. Finally, the cut-away view shown in FIG. 2A shows chamfer/fillet 29 next to raceway edge 28 and inner diameter surface 27.

FIG. 2B illustrates a sequence of operations in the DED repair process of a raceway having an original diameter Dₒ. The first step of the repair process is to thoroughly clean the bearing raceway so that damage locations 23 can be inspected and it can be determined how much material will need to be removed from the damaged raceway as shown in FIG. 2B at bearing disassembly step (a). The substrate diameter Dₛ will be selected based on the depth of the spalls and microcracks in the damaged surface. Next, with the damaged raceway clamped and supported along inner diameter 27, the diameter of the raceway is now reduced down to substrate diameter Dₛ using a conventional style grinding or turning operation. At this point, having removed all damage locations 23, including all spall 25 and microcracks 24, the measured diameter Dₘ will equal the substrate diameter Dₛ as shown in FIG. 2B at material removal step (b). The next step in the repair process is to build-up a cladding layer 57 around the substrate diameter Dₛ surface such that the new measured diameter Dₘ will be larger than the original diameter Dₒ as shown in FIG. 2B at cladding step (c). The novel filler material will be selected using the present invention filler material selection process 200 and may be applied to substrate diameter Dₛ using DED process 50 that will be more fully described in FIGS. 3A and 3B herein. The next step of the repair process is to reduce the built-up cladding layer 57 using a grinding or turning operation so that the measured diameter Dₘ will once again be equal the original diameter Dₒ as shown in FIG. 2B at restoration step (d). At this point the repaired bearing raceway has been returned to its original shape, size, and surface finish. Further heat treatment such as tempering or cryogenic treatment can also be performed at this time (if needed). Since the present invention filler material selection process 200 was used for the repair, the newly repaired bearing raceway will also satisfy the strength and surface hardness requirements of the original bearing raceway allowing it to be placed back into service.

FIG. 3A illustrates a simplified DED processing cross sectional schematic with powder filler material. As previously mentioned herein, patent application US 2024/0255027, titled: “A Method for Manufacturing a Rolling or Plain Bearing”, describes a repair process for bearing raceways using DED. FIG. 3A is a simplified DED process schematic 50 showing an energy beam 54 that is directed towards a repair surface 59. Repair surface 59 as shown in FIG. 3A is depicted as a cross-sectional enlarged view of a bearing raceway, having a similar view to that of inner raceway 20 in FIG. 2A herein. Energy beam 54 produces enough thermal energy to locally melt the substrate 58 and the filler material 53 creating a cladding pass 57 upon solidification. Filler material 53 can be in powder or wire form. For the DED process schematic 50 shown in FIG. 3A, filler material 53 is applied to the substrate 58 by a powder feeding system 52. A single cladding pass 57 is shown in DED process schematic 50 but could be repeated in an overlapping manner as shown in FIG. 3B.

FIG. 3B illustrates a buildup of cladding passes 57 to create a cladding layer 56 using the DED process. FIG. 3A included a simplified DED process schematic 50 showing how a cladding pass 57 is made on substrate 58. Multiple, overlapping cladding passes 57-1, 57-2, 57-3, and 57-4 are shown in FIG. 3B. Each cladding pass 57 is made by slightly offsetting the center of the cladding pass 57 as compared to the previous pass. A portion of the previous cladding pass 57-1 is remelted as the newly formed cladding pass 57-2 is made. Likewise, a portion of cladding pass 57-2 is remelted as the newly formed cladding pass 57-3 is made on the next pass. The overlapping cladding passes 57 can be repeated across the entire repair surface 59. Once completed, the overlapping cladding passes 57 will create a cladding layer that can then be ground or turned to a final diameter. If additional thickness is needed, a second or third cladding layer 56 could be applied on top of the previous cladding layer 56 as well.

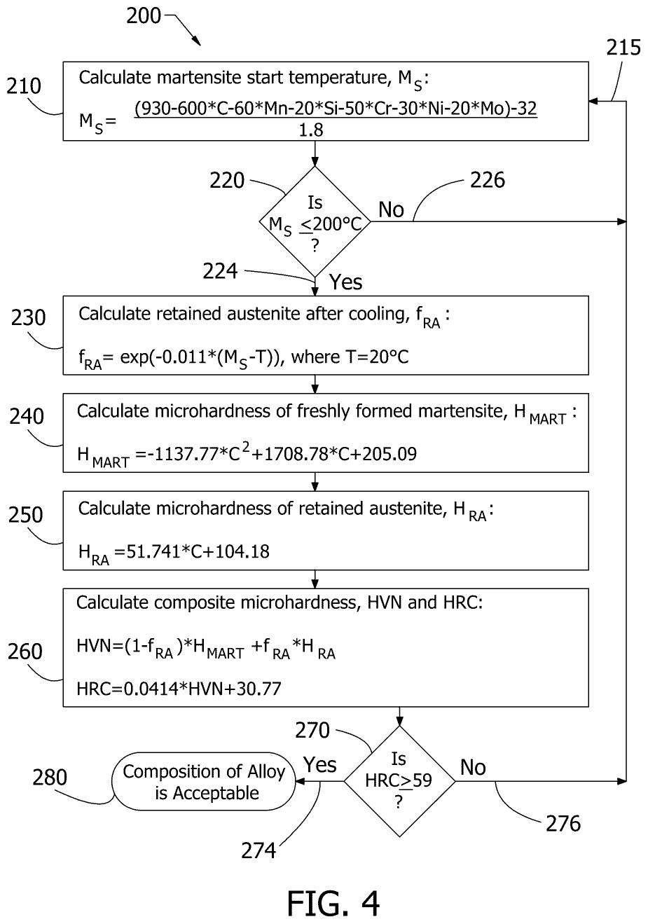

FIG. 4 illustrates the process flow for selecting a suitable alloy for repairing a bearing raceway 200. The present invention process flow 200 begins by completing Step 1—Calculate martensite start temperature (item 210) using [Eq. 1] for the alloy. The Mₛ temperature is represented in units of ° C. Once the Mₛ temperature is calculated, the user can move on to Step 2—Decision Block (item 220), which asks the question is Mₛ<200° C.? If the answer is ‘No’ (item 226), the user must Start Over with Step 1 (item 215). If the answer is ‘Yes’ (item 224), the user can move onto Step 3—Calculate retained austenite after cooling (item 230) using [Eq. 2]. Next, the user can complete Step 4—Calculate microhardness of freshly formed martensite (item 240) using [Eq. 3]. Next, the user can complete Step 5—Calculate microhardness of retained austenite (item 250) using [Eq. 4]. The final set of calculations takes place in Step 6—Calculate composite microhardness (item 260) using [Eqs. 5 & 6]. Finally, the user can move on to Step 7-Decision Block (item 270), which asks the question is HRC≥59 for a single pass composite requirement, assuming that tempering due to multi-pass DED layers will temper the hardness down to 58 HRC? If the answer is ‘No’ (item 276), the user must Start Over with Step 1 (item 215). If the answer is ‘Yes’ (item 274), the user can move onto Step 8-Composition of Alloy is Acceptable (item 280), which completes the process.

The following example uses the process flow selecting a suitable alloy for repairing a bearing raceway 200 as depicted in FIG. 4. The new alloy for DED selected using the novel method 200 meets the goals of the invention. In the example, the temperature at the end of cladding (i.e., room temperature in Eq. 2) is assumed as approximately 20° C. The tempering effect of the multiple passes is assumed to be equivalent to that for one hour @ 370° C. (700° F.).

TABLE 3
Example using Filler Material Selection Process 200
Elemental content in percentage by weight

| Fe | C | Mn | Si | Cr | Ni | Mo | V |
|---|---|---|---|---|---|---|---|
| 94.3 | 0.70 | 1.00 | 0.50 | 1.00 | 2.00 | 0.30 | 0.20 |

Using the present invention filler material selection process 200 previously described in and shown in FIG. 4 herein, the composition listed in Table 3 above yields the following results. The Mₛ temperature is predicted to be 162° C. using [Eq. 1] and the amount of retained austenite is predicted to be 21% by volume using [Eq. 2]. The microhardness of the freshly formed martensite is predicted to be 844 HVN using [Eq. 3] and the microhardness of the retained austenite is predicted to be 140 HVN using [Eq. 4]. The composite microhardness is estimated at 697 HVN (approximately 59.6 HRC) using [Eqs. 5 and 6]. An approximate conversion of the composite hardness meets the 59 HRC minimum for a single pass composite requirement of cladding, assuming that tempering due to multi-pass DED layers will temper the hardness down to 58 HRC.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “rolling contact bearing” and “bearing” are interchangeable and refer to the method for selecting a suitable alloy for repairing a bearing raceway. One skilled in the art would readily recognize that the present invention method for selecting a suitable alloy for repairing a bearing alloy could be adapted to other components other than rolling contact bearings.

Notwithstanding the forgoing, the filler material selection process 200 of the present invention has been described for use with a rolling contact bearing 100. However, the material selection process 200 of the present invention can also be used in other applications besides rolling contact bearings. Further, the filler material selection process 200 of the present invention can be used for manufacturing as well as repairing other high-strength, high surface hardness components and other filler material processing beyond the DED process described herein without affecting the overall concept of the invention, provided that it accomplishes the above stated objectives. One of ordinary skill in the art will appreciate that the example composition alloys listed herein are only shown for illustrative purposes only, and that many other compositions are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for selecting an alloy for repairing a bearing raceway, the method comprising the following steps:
calculating a martensite start temperature for the alloy;
determining if the martensite start temperature is less than 200° C.;
calculating a retained austenite for the alloy;
calculating a microhardness of a martensite for the alloy;
calculating a microhardness of the retained austenite;
calculating a composite microhardness of the alloy; and
determining whether the composite microhardness corresponds to a Rockwell hardness at least 59 HRC for a single pass of a cladding material.

2. The method for selecting an alloy of claim 1, wherein the martensite start temperature is calculated using a first equation.

3. The method of selecting an alloy of claim 2, wherein the retained austenite is calculated using a second equation.

4. The method of selecting an alloy of claim 3, wherein the microhardness of the martensite is calculated using a third equation.

5. The method of selecting an alloy of claim 4, wherein the microhardness of the retained austenite is calculated using a fourth equation.

6. The method of selecting an alloy of claim 5, wherein the composite microhardness is calculated via a fifth equation and a sixth equation.

7. The method of selecting an alloy of claim 6, wherein if the hardness is at least 59 HRC for the single pass of the cladding material, the alloy is selected.

8. An alloy comprising:
a carbon, wherein the carbon is between 0.55 and 0.80 percent by weight of the alloy;
a manganese, wherein the manganese is between 0.05 and 1.50 percent by weight of the alloy;
a silicon, wherein the silicon is between 0.05 and 1.20 percent by weight of the alloy;
a chromium, wherein the chromium is between 0.05 and 2 percent by weight of the alloy;
a nickel, wherein the nickel is between 1 and 7 percent by weight of the alloy;
a molybdenum, wherein the molybdenum is between 0.05 and 1 percent by weight of the alloy; and
a vanadium, wherein the vanadium is between 0 and 0.3 percent by weight of the alloy.

9. The alloy of claim 8, wherein a remaining balance of the alloy is comprised of an iron.

10. The alloy of claim 8, wherein the alloy has a martensite start temperature not exceeding 200° C.

11. The alloy of claim 8, wherein the alloy has a composite microhardness of at least 59 HRC.

12. A method of repairing a bearing raceway, the method comprising the following steps:
cleaning the bearing raceway and determining how much of a material will need to be removed from the bearing raceway;
removing the material from the bearing raceway to a substrate diameter;
applying a cladding layer to the substrate diameter such that a new diameter of the bearing raceway is larger than an original diameter of the bearing raceway;
selecting an alloy by:
calculating a martensite start temperature of the alloy;
determining if the martensite start temperature is less than 200° C.;
calculating a retained austenite of the alloy;
calculating a microhardness of a martensite;
calculating a microhardness of the retained austenite;
calculate a composite microhardness of the alloy; and
determining whether the composite microhardness corresponds to a hardness of at least 59 HRC for a single pass of the cladding layer;
applying the alloy to the substrate diameter if the hardness is at least 59 HRC for the single pass of the cladding layer; and
removing an amount of the cladding layer until the bearing raceway is restored to the original diameter.

13. The method of repairing a bearing raceway of claim 12, wherein applying the cladding layer is comprised of depositing overlapping cladding passes.

14. The method of repairing a bearing raceway of claim 13, wherein the alloy is applied to the substrate diameter via a powder feeding system.

15. The method of repairing a bearing raceway of claim 12 further comprising a step of applying a second cladding layer over the first cladding layer if an additional thickness is required.

16. The method of repairing a bearing raceway of claim 12 further comprising a step of heat treating the bearing raceway after removing the amount of the cladding layer.

17. The method of repairing a bearing raceway of claim 12, wherein the martensite start temperature is calculated using a first equation and the retained austenite is calculated using a second equation.

18. The method of repairing a bearing raceway of claim 12, wherein the microhardness of the martensite is calculated using a third equation and the microhardness of the retained austenite is calculated using a fourth equation.

19. The method of repairing a bearing raceway of claim 12, wherein the composite microhardness is calculated via a fifth equation and a sixth equation.

20. The method of repairing a bearing raceway of claim 12, wherein the alloy selected is comprised of a carbon, wherein the carbon is between 0.55 and 0.80 percent by weight of the alloy, a manganese, wherein the manganese is between 0.05 and 1.50 percent by weight of the alloy, a silicon, wherein the silicon is between 0.05 and 1.20 percent by weight of the alloy, a chromium, wherein the chromium is between 0.05 and 2 percent by weight of the alloy, a nickel, wherein the nickel is between 1 and 7 percent by weight of the alloy, a molybdenum, wherein the molybdenum is between 0.05 and 1 percent by weight of the alloy, a vanadium, wherein the vanadium is between 0 and 0.3 percent by weight of the alloy, and wherein a remaining balance of the alloy is comprised of an iron.
